(19) United States
(12) Patent Application Publication
(10) Pub. No.: US 2014/0051400 A1
(43) Pub. Date: Feb. 20, 2014

(54) METHOD AND SYSTEM OF CAPTURING AUDIO OF A MOBILE PHONE

(71) Applicant: Christopher Anthony Silva, Little Egg Harbor, NJ (US)

(72) Inventor: Christopher Anthony Silva, Little Egg Harbor, NJ (US)

(21) Appl. No.: 13/589,248

(22) Filed: Aug. 20, 2012

(51) Int. Cl. H04W 4/16

(52) U.S. Cl. CPC H04W 4/16
USPC 455/412.1

(57) ABSTRACT

The present invention includes a method and system of gaining access to an audio stream of a mobile phone. An audio stream detour module is inserted in native libraries on the operating system of the mobile phone. The audio stream detour module creates a new route for audio streams of the mobile phone from the microphone or speaker to a point of access. In one embodiment, a call recording module accesses the audio stream from the point of access in order to record the audio stream during a call.

### BACKGROUND OF THE INVENTION

1. Field of the Invention

The present invention relates to a mobile phone in which an audio stream can be captured and redirected.

2. Description of Related Art

FIG. 1 is a schematic diagram of prior art mobile phone 10. Prior art mobile phone 10 contains hardware 12, such as microphones and speakers, or allows the connection of remote microphones and speakers via wireless technology such as Bluetooth, to interface with operating system 14 of the mobile phone as well as applications 16 that run on operating system 14 via native system libraries 17. The uniform set of libraries 17 allow manufacturers to interface different hardware with a standard operating system. Example operating system for smart phones include Android™, Symbian®, Apple iOS™, RIM BlackBerry®, MeeGo®, Windows® Phone and Bada.

Some conventional mobile devices limit only a single application to have access to audio that streams from the operating system to the microphone and/or speaker. It is desirable to have access to the audio streams, without interfering with the original intent of the application using and creating them in order, for example, to record the audio of the audio stream going to the speaker and from the microphone, whether the microphone and speaker are directly connected to the phone or via wireless connection to provide an audible record of a mobile phone call.

### SUMMARY OF THE INVENTION

The present invention includes a method and system of gaining access to an audio stream of a mobile phone. An audio stream detour module is inserted in native libraries on the operating system of the mobile phone. The audio stream detour module creates a new route for audio streams of the mobile phone from the microphone or speaker. The audio stream detour module sends the audio stream to a point of access. The point of access can be created in the native libraries. The point of access can allow an application to have access to the audio stream that is also headed to and from the initial destinations of the microphone and speaker. In one embodiment, the application is a call recording module for recording the audio stream during the call. For example, the audio stream can be audio stream pulse code modulation (PCM) audio. Thereafter, the audio stream detour module of the native library can return the audio stream to its original function to and from the microphone and speaker.

The invention will be more fully described by reference to the following drawings.

### BRIEF DESCRIPTION OF THE DRAWINGS

FIG. 1 is a schematic diagram of a prior art system of a mobile phone.

FIG. 2 is a schematic diagram of a system of a mobile phone in accordance with the teachings of the present invention.

FIG. 3 is a flow diagram of a method of gaining access to an audio stream in accordance with the teachings of the present invention.

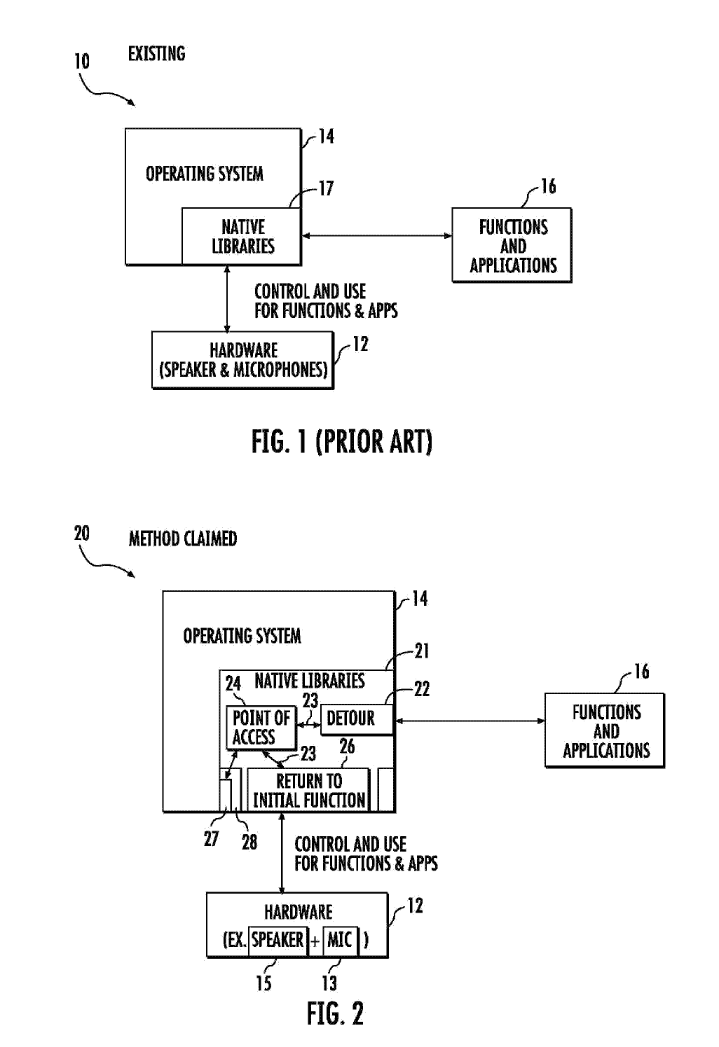

### DETAILED DESCRIPTION

Reference will now be made in greater detail to a preferred embodiment of the invention, an example of which is illustrated in the accompanying drawings. Wherever possible, the same reference numerals will be used throughout the drawings and the description to refer to the same or like parts.

Mobile phone 20 includes operating system 14 which interacts with native libraries 21. Suitable operating systems include Android™, Symbian®, Apple iOS™, RIM BlackBerry®, MeeGo®, Windows® Phone and Bada. Mobile phone 20 contains hardware 12, such as microphones 13 and speakers 15, or allows the connection of remote microphones and speakers via wireless technology such as Bluetooth, to interface with operating system 14 of the mobile phone as well as applications 16 that run on operating system 14 via native system libraries 21. Functions and applications 16 use functions of native libraries 21 to establish and maintain calls with mobile phone 20 and for sending and receiving audio stream 23 within the calls.

Native libraries 21 include audio stream detour module 22 for sending audio stream 23 to point of access module 24 within native libraries 21. The point of access module 24 creates a point of access in native libraries 21. The point of access can allow an application to have access to audio stream 23 that is also headed to and from the initial destinations of microphone 13 and speaker 15. For example, audio stream 23 can be pulse code modulation (PCM) audio an audio stream received or sent by the microphone and/or speaker. Audio data of audio stream 23 can be compressed into a waveform or similar digital audio file in audio format. Thereafter, native library 21 can return audio stream 23 to its original function to and from microphone 13 and speaker 15. In one embodiment, application 16 is a call-recording application for recording which accesses point of access module 24. The call recording application can compress the audio stream or pulse code modulation (PCM) packets and store the one or more files for captured audio stream or audio packets from the internal call in local storage 27 using storage module 28. The call-recording application can determine call data and associate the call data with the one or more files for the captured audio stream or audio packets from the internal call. The call-recording application can include software for digital watermarking, fingerprinting and encryption. Audio stream 23 the audio stream to return to an original function in operating system 14 of the mobile phone for the microphone and/or speaker.

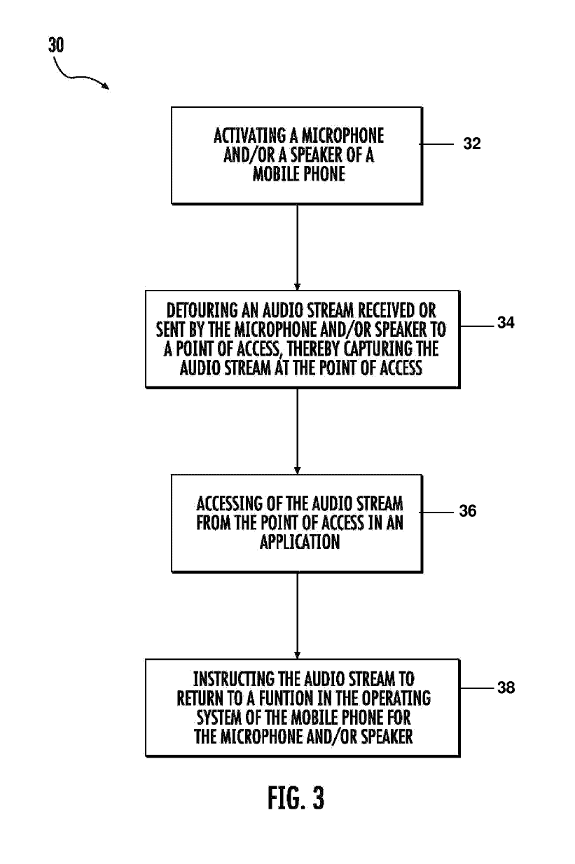

FIG. 3 is a schematic diagram of a method of gaining access to an audio stream of a mobile phone 30. In block 32, a microphone and/or speaker of a mobile phone is activated. In block 34, an audio stream received or sent by the microphone and/or speaker is detoured using an audio detour module to a point of access. In block 36, the audio stream is accessed from the point of access by an application. For example, the application can be an application for recording the captured audio stream. In block 38, the audio stream detour module instructs the audio stream to return to an original function in the operating system of the mobile phone for the microphone and/or speaker.

Embodiments of the present invention may be implemented in connection with a special purpose or general purpose telecommunications device that include both hardware and/or software components, including wireless telephones and other telephony-enabled wireless devices, landline telephones, or special purpose or general purpose computers that are adapted to have telecommunications capabilities.

Embodiments may also include physical computer-readable media and/or intangible computer-readable media for carrying or having computer-executable instructions, data structures, and/or data signals stored thereon. Such physical computer-readable media and/or intangible computer-readable media can be any available media that can be accessed by a general purpose or special purpose computer. By way of example, and not limitation, such physical computer-readable media can include RAM, ROM, EEPROM, CD-ROM or other optical disk storage, magnetic disk storage or other magnetic storage devices, other semiconductor storage media, or any other physical medium which can be used to store desired data in the form of computer-executable instructions, data structures and/or data signals, and which can be accessed by a general purpose or special purpose computer. Within a general purpose or special purpose computer, intangible computer-readable media can include electromagnetic means for conveying a data signal from one part of the computer to another, such as through circuitry residing in the computer.

When information is transferred or provided over a network or another communications connection (either hardwired, wireless, or a combination of hardwired or wireless) to a computer, hardwired devices for sending and receiving computer-executable instructions, data structures, and/or data signals (e.g., wires, cables, optical fibers, electronic circuitry, chemical, and the like) should properly be viewed as physical computer-readable mediums while wireless carriers or wireless mediums for sending and/or receiving computer-executable instructions, data structures, and/or data signals (e.g., radio communications, satellite communications, infrared communications, and the like) should properly be viewed as intangible computer-readable mediums. Combinations of the above should also be included within the scope of computer-readable media.

Computer-executable instructions include, for example, instructions, data, and/or data signals which cause a general purpose computer, special purpose computer, or special purpose processing device to perform a certain function or group of functions. Although not required, aspects of the invention have been described herein in the general context of computer-executable instructions, such as program modules, being executed by computers, in network environments and/or non-network environments. Generally, program modules include routines, programs, objects, components, and content structures that perform particular tasks or implement particular abstract content types. Computer-executable instructions, associated content structures, and program modules represent examples of program code for executing aspects of the methods disclosed herein.

Embodiments may also include computer program products for use in the systems of the present invention, the computer program product having a physical computer-readable medium having computer readable program code stored thereon, the computer readable program code comprising computer executable instructions that, when executed by a processor, cause the system to perform the methods of the present invention.

It is to be understood that the above-described embodiments are illustrative of only a few of the many possible specific embodiments, which can represent applications of the principles of the invention. Numerous and varied other arrangements can be readily devised in accordance with these principles by those skilled in the art without departing from the spirit and scope of the invention.

What is claimed is:

1. A method for capturing audio of a mobile phone comprising the steps of:
activating a microphone and/or a speaker of a mobile phone; and
detouring an audio stream received or sent by the microphone and/or speaker to a point of access, thereby capturing the audio stream at the point of access.

2. The method of claim 1 wherein said detouring step is performed in a native library used in an operating system of the mobile phone.

3. The method of claim 1 further comprising the step of:
accessing of the audio stream from the point of access in an application.

4. The method of claim 1 wherein after the step of detouring an audio stream, further comprising the step of:
instructing the audio stream to return to a function in the operating system of the mobile phone for the microphone and/or speaker.

5. The method of claim 3 wherein said application is an application for recording of the captured audio stream.

6. The method of claim 1 wherein the audio stream is pulse code modulation audio.

7. A system for capturing audio of a mobile phone comprising:
an audio stream detour module in a library communicating with an operating system of the mobile phone, the audio stream detour module receiving an audio stream received and/or sent by the microphone and/or speaker of the mobile phone and sending the received audio stream to a point of access.

8. The system of claim 7 further comprising an application for accessing of the audio stream at the point of access.

9. the system of claim 8 wherein the application is an application for recording of the captured audio stream.

10. The system of claim 7 wherein after the sending of the received audio stream to the point of access the audio stream detour module instructs the audio stream to return to a function in the operating system of the mobile phone for the microphone and/or speaker.
